(19) United States
(12) Patent Application Publication
(10) Pub. No.: US 2026/0082222 A1
(43) Pub. Date: Mar. 19, 2026

(54) PROVISIONING WIRELESS PRIORITY SERVICE PRIVILEGES IN A WIRELESS TELECOMMUNICATION NETWORK

(71) Applicant: T-MOBILE INNOVATIONS LLC, Overland Park, KS (US)

(72) Inventor: Ariful Islam KAZI, Renton, WA (US)

(21) Appl. No.: 18/888,115

(22) Filed: Sep. 17, 2024

(51) Int. Cl. H04W 12/06; H04W 12/72

(52) U.S. Cl. CPC H04W 12/06; H04W 12/72

(57) ABSTRACT

Systems and method are contemplated herein for methods for determining whether to authorize a user’s access to restricted telecommunication service, such as the wireless priority service. When certain attributes of a user profile are modified, a logic flow is performed that provisions a profile attribute of the user for accessing the restricted telecommunication service. The logic flow includes ensuring that a user is active and associated with a billing code or account identifier of an entity or organization having access to the restricted telecommunication service.

The present disclosure is directed, in part to provisioning wireless priority service privileges, substantially as shown and/or described in connection with at least one of the figures, and as set forth more completely in the claims.

According to various aspects of the technology, various network technologies may be used to provision access to restricted telecommunication systems. Some telecommunication services, such as the Department of Homeland Security (DHS) Wireless Priority Service (WPS), operate by granting priority telecommunication access to pre-authorized users. In the case of WPS, priority access is granted to first responders, military operators, and government officials for emergency/contingency operations and continuity of operations. Though access is limited, some services (like WPS) have a significant number of devices authorized to utilize the restricted service. Programming the correct permissions to access the restricted service, also known as provisioning, is done by mobile network operators (MNOs). Ensuring the correct users are provisioned with access to a restricted service is done manually, introducing lag and inaccuracy. In contrast, the concept describe herein improves restricted access provisioning by utilizing a network of computer components to automatically detect profile changes and provision the necessary permissions for devices to reduce lag and increase accuracy.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of an exemplary logic flow for provisioning wireless priority service privileges in which implementations of the present disclosure may be employed; and

FIG. 4 illustrates a flow diagram of a method for provisioning wireless priority service privileges for use with the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a restricted telecommunication service grants priority access to users or user equipment (UE) based on the user or UE satisfying an access requirement. One such restricted telecommunication service is the Department of Homeland Security’s Wireless Priority Service (WPS). The WPS allows users to make priority voice calls using a mobile network operator’s radio access network by dialing an access code (e.g., a prefix of *272) and then the destination number. Restricted telecommunication services, such as the WPS are meant to be used in an emergency or disaster recovery situation when cellular networks are congested and the probability of completing a normal cellular call is reduced. WPS calls do not preempt calls in progress, but provide priority status to the user initiating the priority call over other calls being placed contemporaneously by other non-priority users. Generally, entities or organizations with emergency, disaster recovery, or governmental command and control responsibilities are authorized to use the WPS.

In contrast to conventional solutions, in which access to restricted access systems is provisioned manually, the present disclosure is directed to systems and methods for improving restricted access provisioning in a cellular telecommunication network. Using a networked architecture, any one of a predetermined number of profile modifications can be used to trigger an automated profile review of a user to determine if they should or should not have access to a restricted access telecommunication service, such as WPS. By ensuring that a user has an active device and that the user is associated with a billing account of an entity that is approved for accessing the restricted telecommunication service, the MNO can be sure that the right users have the right permissions. If a user’s profile requires changes to align their profile with their determined access entitlement, then the changes are automatically provisioned, reconciling the discrepancy.

Accordingly, a first aspect of the present disclosure is directed to a system for provisioning access to a restricted telecommunication service. The system comprises a plurality of networked telecommunication computer processing components, a networked data repository, and one or more non-transitory computer readable media having instructions stored thereon that, when executed by the plurality of networked telecommunication computer processing components, cause the plurality of networked telecommunication computer processing components to perform operations. The operations comprise receiving, at a restricted access priority module, an indication to initiate a logic flow. The operations further comprise querying a profile repository to retrieve a plurality of profile attributes associated with the user, the plurality of profile attributes comprising an active status and a billing code associated with an account of the user. The operations further comprise, based on the plurality of profile attributes, causing a restricted access attribute to be stored in the networked data repository, the restricted access attribute indicating the user’s authorization to utilize the restricted telecommunication service.

Another aspect of the present disclosure is directed to a method for managing access to a wireless priority service. The method comprises receiving, at a restriction module, an indication to initiate a logic flow. The method further comprises querying a profile repository to retrieve a plurality of profile attributes associated with the user, the plurality of profile attributes comprising an active status and a billing code associated with an account of the user. The method further comprises based on the plurality of profile attributes, causing a restricted access attribute to be stored in the networked data repository, the restricted access attribute indicating the user’s authorization to utilize the wireless priority service.

Another aspect of the present disclosure is directed to A non-transitory computer readable media having computer executable instructions stored thereon that, when executed by one or more computer processing components, cause the one or more computer processing components to perform operations for managing access to a wireless priority service. The operations comprise receiving, at a restriction module, an indication to initiate a logic flow. The operations further comprise querying a profile repository to retrieve a plurality of profile attributes associated with the user, the plurality of profile attributes comprising an active status and a billing code associated with an account of the user. The operations further comprise based on the plurality of profile attributes, causing a restricted access attribute to be stored in the networked data repository, the restricted access attribute indicating the user’s authorization to utilize the restricted telecommunication service.

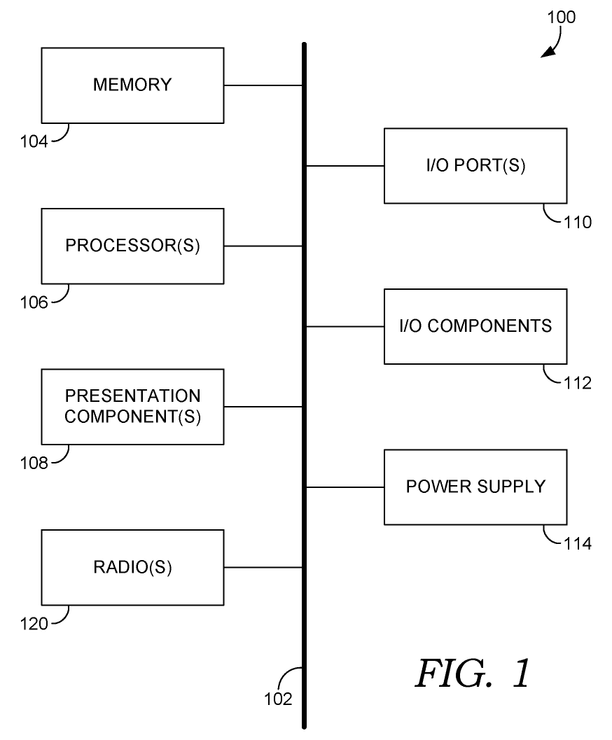

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, one or more input/output (I/O) ports 110, one or more I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of the one or more I/O components 112. Also, processors, such as the one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as the bus 102, the memory 104 or the one or more I/O components 112. The one or more presentation components 108 presents data indications to a person or other device. Exemplary one or more presentation components 108 include a display device, speaker, printing component, vibrating component, etc. The one or more I/O ports 110 allow computing device 100 to be logically coupled to other devices including the one or more I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, the radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

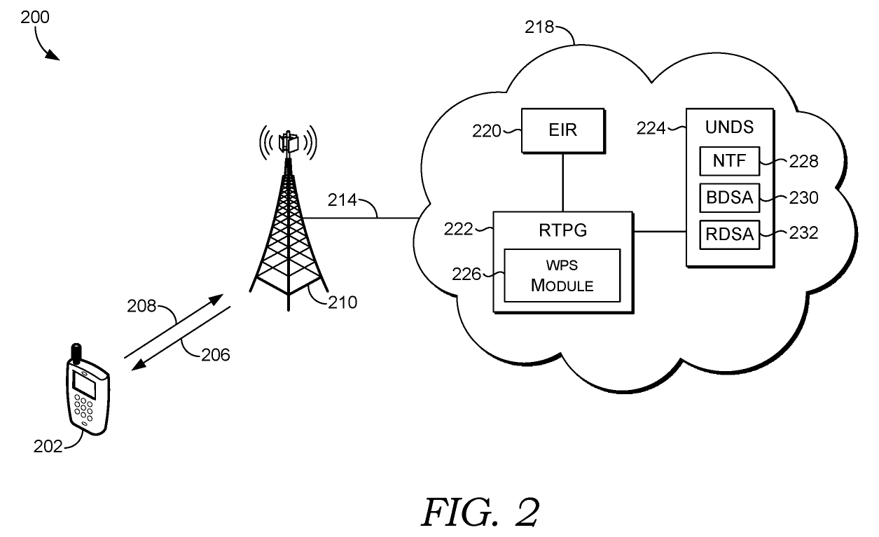

Referring now to FIG. 2, a representative network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment 200 be interpreted as having any dependency or requirement relating to any one or combination of components illustrated.

Network environment 200 represents a high level and simplified view of relevant portions of one or more modern wireless telecommunication networks. At a high level, the network environment 200 may generally be said to comprise one or more UEs, such as a UE 202, one or more base stations, such as a base station 210, and a core network 218, though in some implementations, it may not be necessary for certain features to be present. Similarly, while each component is shown in the singular, it is expressly contemplated that there may be more than one of the components described. The network environment may include a number of routers, switches, and the like. The network environment 200 is generally configured for wirelessly connecting the UE 202 to data or services that may be accessible on one or more application servers or other functions, nodes, or servers not pictured in FIG. 2 so as to not obscure the focus on the present disclosure.

The network environment 200 comprises the UE 202. The UE 202 is illustrated generally, and may take any number of forms, including a tablet, phone, or wearable device, or any other device discussed with respect to FIG. 1 and may have any one or more components or features of the computing device 100 of FIG. 1. In aspects, the UE 202 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The network environment 200 comprises one or more of the base station 210 to which the UE 202 may potentially connect to (also referred to as ‘camping on,’ ‘attaching,’ in the industry). Though network environment 200 is illustrated with one base station 210, one skilled in the art will appreciate that more or fewer base stations may be present in any particular network environment. The base station 210 of the network environment 200 is configured to wirelessly communicate with UEs, such as the UE 202. In aspects, the base station 210 may communicate with the UE 202 using any wireless telecommunication protocol desired by a network operator, including but not limited to 2G, 3G, 4G, 5G, 6G, 802.11x and the like.

The base station 210 is configured to communicate with one or more UEs, such as the UE 202. The base station 210 may communicate signals to one or more UEs via a downlink 206 and receive signals from one or more UEs via uplink 208. In response to receiving certain requests to and/or from the UE 202, the base station 210 may communicate with the core network 218 via a backhaul 214. For example, in order for the UE 202 to connect to a desired network service (e.g., PSTN call, voice over LTE (VoLTE) call, voice over new radio (VoNR), data, or the like), the UE 202 may communicate an attach request to the base station 210, which may, in response, communicate a registration request to the core network 218 via the backhaul 214.

The core network 218 may comprise one or more network functions (NFs). As used herein, the term “network function” is used to describe a computer processing module and/or one or more computer executable services being executed on one or more computing processing modules. NFs within the core network 218 are defined by their function, as the core network 218 is a service-based architecture. The core network 218 may comprise NFs that include any one or more of an equipment identity register (EIR) 220, a real-time provisioning gateway (RTPG) 222, and a unified network directory server (UNDS) 224. Each of these NFs may communicate with each other, directly or indirectly, via interfaces existing between them. Each of the preceding NFs may take different forms, including consolidated or distributed forms that perform the same general operations. In other architectures or protocols, the NFs may be given other names, however, the NFs herein refer to functions, not specifically identified components. For example, the EIR 220 may instead be a different device management platform.

Though the EIR 220, the RTPG 222, and the UNDS 224 are illustrated in the core network 218, the core network 218 may have more or fewer NFs than shown. For example, the core network 218 may include a provisioning gateway (PGW), and in some aspects, the PGW may be another component of the UNDS 224. Further, though EIR 220, the RTPG 222, and the UNDS 224 are illustrated as disposed within the core network 218, it is expressly contemplated that the location in the network environment 200 is non-limiting. For example, the NFs described above may be disposed between the base station 210 and the core network 218 (i.e., the network edge) or may be isolated as stand-alone components, or a combination of these. While each of the NFs described above are illustrated in the singular, it is expressly contemplated that the network environment 200 may include one or more of each of the NFs described above.

The EIR 220, for example, is generally responsible for managing device information (e.g., international mobile equipment identities (IMEIs)) which allows the network to allow, monitor, or block devices attempting to access the network. The EIR 220 may communicate with the UNDS 224, such as to update device information stored at the UNDS 224 (e.g., the EIR 220 communicates the UE 202 is blocked from accessing the network, and the UNDS 224 stores this determination in one or more of its directories).

The RTPG 222, for example, is generally responsible for facilitating the activation, deactivation, and management of services for users of the network, ensuring that service changes are processed and applied in real-time. The RTPG 222 may comprise a wireless priority service (WPS) module 226. The WPS module 226 is generally responsible for managing the provisioning of WPS access for the UE 202; though WPS is discussed herein, the present disclosure is directed to provisioning access to a restricted-access priority telecommunication service. Wireless Priority Service (WPS) is a U.S. government program that gives authorized users priority access to wireless networks during emergencies when networks are congested. It ensures that critical users, such as first responders and government officials, can initiate and maintain communications in situations where regular users may experience delays or inability to connect. When a user dials a prefix (e.g., *272) to initiate a Wireless Priority Service (WPS) call, the Mobile Network Operator (MNO) verifies whether the user is authorized through a process involving the user's subscription and SIM authentication. The user's SIM card is linked to a subscription for WPS, which is stored in a centralized database managed by the MNO or the WPS system. Only users who are enrolled in the WPS program are included in this database, which the MNO can query when a WPS call is attempted. When the user dials the correct activating prefix before the number, the network first checks the SIM card’s credentials to verify the user's identity. The system uses the SIM authentication process to ensure that the request is coming from an authorized device. The network recognizes the activating prefix as a WPS indicator and checks the subscription database to confirm that the caller's SIM is authorized for WPS service. If the user is not enrolled, the priority treatment will not be applied, and the call will be processed like any other standard call.

The UNDS 224, for example, is generally responsible for centralizing and consolidating user and network data across multiple systems in the one or more directories of the UNDS 224, providing a single source of information for efficient network management. The UNDS 224 may comprise a network trigger function (NTF) 228, a backend directory server agent (BDSA) 230 (i.e., the one or more directories of the UNDS 224), and a routing directory server agent (RDSA) 232. While each of the NTF 228, the BDSA 230, and the RDSA 232 are shown in the singular, it is expressly contemplated that there may be more than one of each of the NTF 228, the BDSA 230, and the RDSA 232. The NTF 228 may, for example, generally be responsible for causing the WPS module 226 to initiate a logic flow. The BDSA 230 may, for example, store the user profile information relevant to the WPS module 226. The RDSA 232 may, for example, direct various NFs to particular user profile information stored by the BDSA 230.

Relevant to the present disclosure, the WPS module 226 may be configured to perform a logic flow. During the logic flow, the WPS module 226 may retrieve various user profile information from one or more network components (e.g., the RTPG 222, the WPS module 226, and/or the UNDS 224). Based on at least some of the user profile information, the WPS module 226 determines whether a particular user (e.g., a user associated with the UE 202) is eligible for access to WPS. If the WPS module 226 determines the user is eligible for access to WPS, the WPS module 226 may modify the RSI of the user to effectuate the UE 202’s access to WPS.

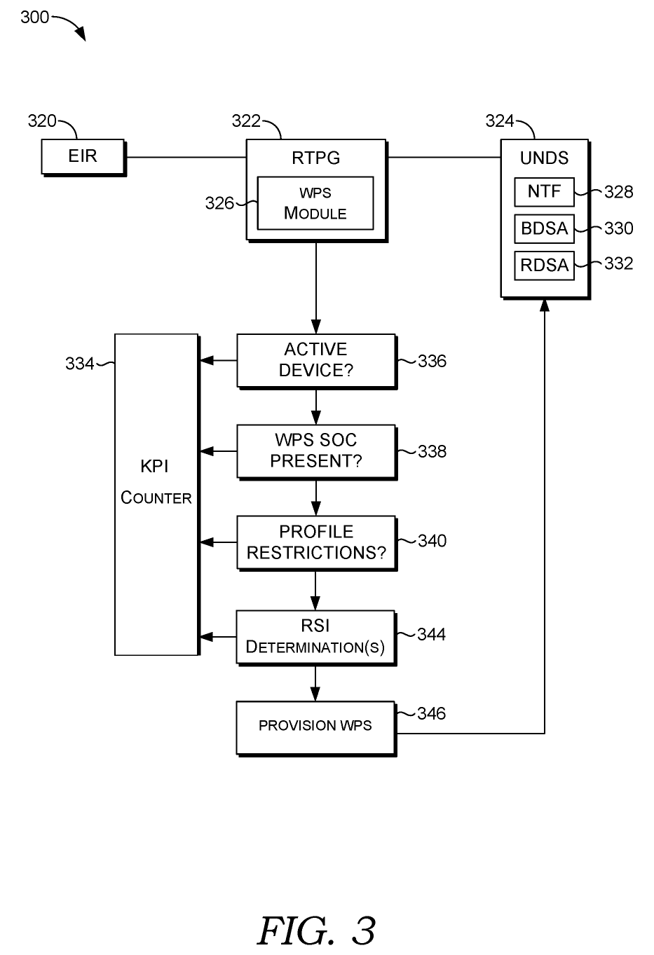

Turning now to FIG. 3, a logic flow diagram is illustrated in accordance with one or more aspects of the present disclosure. A logic flow 300 may be performed by and/or facilitated by one or more NFs discussed in greater detail herein and is not meant to exhaustively show every interaction that would be necessary to practice the invention, so as not to obscure the present disclosure. The logic flow 300 may generally involve an EIR 320 (e.g., the EIR 220 of FIG. 2), an RTPG 322 (e.g., the RTPG 222 of FIG. 2), and a UNDS 324 (e.g., the UNDS 224 of FIG. 2). The RTPG 322 may include a WPS module 326 (e.g., the WPS module 226 of FIG. 2). The UNDS 324 may include an NTF 328 (e.g., the NTF 228 of FIG. 2), a BDSA 330 (e.g., the BDSA 230 of FIG. 2), an RDSA 232 (e.g., the RDSA 232 of FIG. 2), and a key performance indicator (KPI) counter 334. Each of the preceding NFs may take different forms, including consolidated or distributed forms that perform the same general operations. In other architectures or protocols, the NFs may be given other names, however, the NFs herein refer to functions, not specifically identified components. While the steps and processes described with respect to FIG. 3 are described in a specific sequence, it is within the bounds of this disclosure that the steps/processes may be completed in a different order than described.

The logic flow 300 includes the KPI counter 334, which is generally responsible for collecting, storing, organizing, and/or allocating KPIs associated with the logic flow 300. For example, if a user is found to be unauthorized for WPS, the occurrence of this determination may be communicated to the KPI counter 334 by the restriction module 326. Further, for example, if the user is found to be eligible for access to WPS, the occurrence of this determination may similarly be communicated to the KPI counter 334. In aspects, the KPI counter 334 is a subcomponent and/or a module of one of the EIR 320, the RTPG 322, or the UNDS 326. In some aspects, the KPI counter 334 collects, stores, and organizes the determinations in the KPI counter 334, and in other aspects, the KPI counter 334 collects, organizes, and allocates the determination to other network components or other NFs (e.g., a performance management system (PMS), a network management system (NMS)). The KPI counter 334 may additionally collect, store, organize, and/or allocate data associated with the determination, such as the information relevant to the determination (e.g., the user identifier information, the MNO information, the device information, the restriction determination, and/or the RSI associated with the user). The KPI counter 334 may collect metadata such as time of determination, network access type of the user, and the like.

In aspects, the logic flow 300 may be initiated by the RTPG 322 and/or the restriction module 326 receiving an indication to initiate the logic flow 300. The restriction module 326 may be configured to initiate the logic flow 300 upon receipt of the indication. In some aspects, the indication is received by the RTPG 322 and/or the restriction module 326 from one of the UNDS 324 or the EIR 320. The EIR 320 may be configured to identify particular device changes associated with the user, and in response, notify the RTPG 320 and/or the restriction module 326 of the device changes (e.g., in the indication to initiate the logic flow 300). The NTF 328 of the UNDS 324 may be configured to identify particular provisioning changes associated with the user, and in response, notify the RTPG 320 and/or the restriction module 326 of the provisioning changes (e.g., in the indication to initiate the logic flow 300). In other aspects, the indication to initiate the logic flow 300 may be communicated by only the UNDS 324. In such aspects, the EIR 320 may communicate with the UNDS 324 and update one or more user profile information databases of the UNDS 324 (e.g., the BDSA 330) of one or more device changes associated with the user. In such aspects, the NTF 328 of the UNDS 324 may be configured to identify specified provisioning and device changes associated with the user and/or the device associated with the user, and in response, notify the RTPG 322 and/or the restriction module 326 of the provisioning and/or device changes (e.g., in real-time), causing the logic flow 300 to initiate. In other aspects, the logic flow 300 is manually initiated, such as by an MNO.

Provisioning changes and device changes associated with the user may take a number of possible forms. Provisioning changes generally include changes to plans the user is subscribed to, changes to the subscriber identity module (SIM) card, mobile station international subscriber directory number (MSISDN) changes, service activation, service deactivation, service reactivation, and the like. Examples of triggers that may initiate the logic flow 300 comprise a change to a billing code (e.g., napSubscriberSoc/napSocCode), RSI information (e.g., subinnss/refRoamSubscriptionInfoName), access restrictions (e.g., subinnss/accessRestr), core network restrictions (e.g., epsdata/epsCoreNetworkRestr), mobility data (e.g., AccessAndMobilitySubscriptionData/coreNetworkTypeRestrictions), and zone code (epsPsRszi/zonecode).

Once the logic flow 300 is initiated, the WPS module 326 may retrieve user profile information associated with a user. User profile information may include any one or more of user identifier information, MNO information, device information, billing information, and roaming subscriber information (RSI). In some aspects, the WPS module 326 retrieves the user profile information before making any determinations based on the user profile information.

The WPS module 326 may retrieve user and/or device identifier information associated with the user. User identifier information may include any one or more of an MSISDN, an international mobile equipment identity (IMSI), an IMEI, an IP address, globally unique permanent identifier (GUPI), subscription permanent identifier (SUPI), and the like. In some aspects, the WPS module 326 retrieves the user identifier information from the indication causing the logic flow 300 to initiate. For example, the WPS module 326 may receive a notification and/or communication (i.e., the indication) from the RTPG and/or the UNDS 324 (e.g., the NTF 328 of the UNDS 324). In some aspects, at least some of the user identifier information is retrieved from the indication. In other aspects, the restriction module 326 retrieves the user identifier information from the UNDS 324. In such aspects, the RDSA 332 may direct the restriction module 326 to one or more areas of the UNDS 324, such as to one or more BDSAs (e.g., the BDSA 332).

At a status step 336, the WPS module 326 may use one or more user or device identifiers, such as a mobile station international subscriber directory number (MSISDN), an international mobile subscriber identity (IMSI), international mobile equipment identity (IMEI), mobile equipment identifier (MEID), media access control (MAC) address, global unique temporary identifier (GUTI), and a type allocation code (TAC), to determine whether or not a user is active. If it is determined that the user is not active at the status step 336, RTPG 322 will provision to remove WPS access for the user and the result will be logged at the KPI counter 334. If it is determined that the user is active at the status step 336, then the logic flow 300 continues to the account step 338. At the account step 338, it is determined whether or not the user is associated with an account/billing code that is associated with WPS access. For example, if the user is associated with an account code that has WPS access such as the Department of Homeland Security or a local police department, then the logic flow 300 will continue to a restriction inquiry step 340. If the user is not associated with an account code that has WPS access, then RTPG 322 will provision to remove WPS access for the user and the result will be logged at the KPI counter 334.

At the restriction inquiry step 340, the WPS module 326 may retrieve restriction information associated with the user. Restriction information may include a restriction indicator. The user profile stored within the UNDS 324 may include the restriction indicator and/or be modified to include the restriction indicator. One or more NFs and/or entities (e.g., the RTPG 322, the UNDS 324, the MNO that owns and operates the network) may add the restriction indicator to the user profile including the user profile information. The restriction indicator may determine whether the restriction indicator should indicate the user is eligible for WPS or not. In some aspects, the restriction indicator is added ad hoc, and in other aspects, the restriction indicator is added during the logic flow 300. The presence and/or value of the restriction indicator may be based SIM card attributes (e.g., roaming capabilities and/or preferences, compatible services, access point name (APN) settings). If the user’s profile has restrictions associated with WPS access, then the logic flow continues to a mapping step 342. If the user’s profile does not have restrictions associated with WPS or if the user’s profile has other restrictions, then then RTPG 322 will provision to remove WPS access for the user and the result will be logged at the KPI counter 334.

At an RSI determination step 344, the WPS module 326 may retrieve RSI associated with the user. The WPS module 326 may retrieve the RSI from the user profile stored within the UNDS 324. In such aspects, the RDSA 332 may direct the WPS module 326 to one or more areas of the UNDS 324, such as to one or more BDSAs (e.g., the BDSA 332). The RSI may include one or more restrictions (i.e., access restriction entries within the RSI). For example, the user may already have an RSI associated with an authorization to access WPS. The WPS module 326 may make one or more RSI determinations at the RSI determination step 344 based on the RSI information. In some aspects, the one or more RSI determinations include determining whether the WPS RSI is present and/or accessible in the user profile. If the WPS module 326 has determined at steps 336-340 that the user is authorized for WPS, then the RSI(s) of the user is checked at the RSI determination step 344 to determine whether or not the RSI associated with WPS authorization is in the user’s profile. If the RSI associated with allowing the user to access WPS is present, then the logic flow 300 ends and the result will be logged at the KPI counter 334. If the RSI associated with allowing the user to access WPS is not present in the profile of the user, then the logic flow 300 continues to a provisioning step 346. At the provisioning step 346, one or more fields, attributes, or the like that are required for the user’s attempt to access WPS to be authorized will be provisioned in the user’s profile and the KPI counter 334 will be updated.

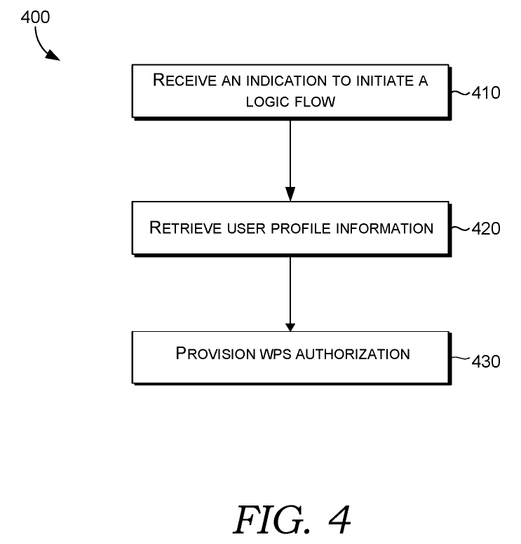

Turning now to FIG. 4, a flow chart is provided that illustrates one or more aspects of the present disclosure relating to a method 400 determining whether to provision WPS access for a user. The method 400 may include one or more aspects described with respect to FIGS. 2-3.

At a first step 410, a WPS module (e.g., the WPS module 226 of FIG. 2, the restriction module 326 of FIG. 3) may receive an indication to initiate the logic flow (e.g., the logic flow 300 of FIG. 3). In aspects, the indication is based on one or more of device changes and/or provisioning changes associated with the user, as described with respect to FIG. 3. At a second step 420, the WPS module retrieves user profile information associated with the user. In aspects, the WPS module retrieves the user profile information during the logic flow. The user profile information may include any one or more of user identifier information, a billing code of the account associated with the user, MNO information, device information, restriction information, and/or RSI associated with the user, as described with respect to FIG. 3. At a third step 430, the WPS module determines whether the user should have access to WPS and provisions the user’s WPS permissions accordingly, according to any one or more aspects described herein with respect to FIGS. 2-3.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for provisioning access to a restricted telecommunication service, the system comprising:
a plurality of networked telecommunication computer processing components;
a networked data repository; and
one or more non-transitory computer readable media having instructions stored thereon that, when executed by the plurality of networked telecommunication computer processing components, cause the plurality of networked telecommunication computer processing components to perform operations comprising:
receiving, at a restricted access priority module, an indication to initiate a logic flow;
querying a profile repository to retrieve a plurality of profile attributes associated with the user, the plurality of profile attributes comprising an active status and a billing code associated with an account of the user; and
based on the plurality of profile attributes, causing a restricted access attribute to be stored in the networked data repository, the restricted access attribute indicating the user’s authorization to utilize the restricted telecommunication service.

2. The system of claim 1, wherein the restricted telecommunication service is wireless priority service (WPS).

3. The system of claim 2, wherein the indication to initiate the logic flow comprises a change to one or more of the billing code associated with the account of the user, a roaming subscription information attribute, and an access restriction.

4. The system of claim 3, wherein the restricted access attribute indicates the user is not authorized to access the restricted telecommunication service based on the active status indicating a user identifier associated with the user is not active.

5. The system of claim 4, wherein the user identifier is a mobile station international subscriber directory number (MSISDN).

6. The system of claim 5, wherein the operations further comprise logging the storage of the restricted access attribute in a key performance indicator (KPI) counter.

7. The system of claim 3, wherein the restricted access attribute indicates the user is not authorized to access the restricted telecommunication service based on the billing code associated with the account of the user not being associated with an entity or organization that is authorized to use the restricted telecommunication service.

8. The system of claim 7, wherein the operations further comprise logging the storage of the restricted access attribute in a key performance indicator (KPI) counter.

9. The system of claim 3, wherein the restricted access attribute indicates the user is authorized to access the restricted telecommunication service based on the billing code associated with the account of the user being associated with an entity or organization that is authorized to use the restricted telecommunication service and based on the active status indication a user identifier associated with the user is active, the user identifier comprising a mobile station international subscriber directory number (MSISDN).

10. The system of claim 7, wherein the operations further comprise provisioning a roaming subscriber identifier (RSI) with the user’s profile based on the restricted access attribute indicating the user is authorized to access the restricted telecommunication service.

11. The system of claim 8, wherein the operations further comprise, subsequent to storing the restricted access attribute in the networked data repository, receiving an indication that the an access attempt to the restricted telecommunication service has been placed by the user and approving the access attempt.

12. A method for managing access to a wireless priority service, the method comprising:
receiving, at a restriction module, an indication to initiate a logic flow;
querying a profile repository to retrieve a plurality of profile attributes associated with the user, the plurality of profile attributes comprising an active status and a billing code associated with an account of the user; and
based on the plurality of profile attributes, causing a restricted access attribute to be stored in the networked data repository, the restricted access attribute indicating the user’s authorization to utilize the wireless priority service.

13. The method of claim 12, wherein the restricted access attribute indicates the user is not authorized to access the wireless priority service based on the active status indicating a mobile station international subscriber directory number (MSISDN) associated with the user is not active.

14. The method of claim 12, wherein the restricted access attribute indicates the user is not authorized to access the wireless priority service based on the billing code associated with the account of the user not being associated with an entity or organization that is authorized to use the wireless priority service.

15. The method of claim 12, wherein the restricted access attribute indicates the user is authorized to access the wireless priority service based on the billing code associated with the account of the user being associated with an entity or organization that is authorized to use the wireless priority service and based on the active status indicating that a mobile station international subscriber directory number (MSISDN) associated with the user is active.

16. The method of claim 15, wherein the operations further comprise provisioning a roaming subscriber identifier (RSI) with the user’s profile based on the restricted access attribute indicating the user is authorized to access the wireless priority service.

17. A non-transitory computer readable media having computer executable instructions stored thereon that, when executed by one or more computer processing components, cause the one or more computer processing components to perform operations for managing access to a wireless priority service, the operations comprising:
receiving, at a restriction module, an indication to initiate a logic flow;
querying a profile repository to retrieve a plurality of profile attributes associated with the user, the plurality of profile attributes comprising an active status and a billing code associated with an account of the user; and
based on the plurality of profile attributes, causing a restricted access attribute to be stored in the networked data repository, the restricted access attribute indicating the user’s authorization to utilize the restricted telecommunication service.

18. The non-transitory computer readable media of claim 17, wherein the restricted access attribute indicates the user is not authorized to access the wireless priority service based on the active status indicating a mobile station international subscriber directory number (MSISDN) associated with the user is not active.

19. The non-transitory computer readable media of claim 17, wherein the restricted access attribute indicates the user is not authorized to access the wireless priority service based on the billing code associated with the account of the user not being associated with an entity or organization that is authorized to use the wireless priority service.

20. The non-transitory computer readable media of claim 17, wherein the restricted access attribute indicates the user is authorized to access the wireless priority service based on the billing code associated with the account of the user being associated with an entity or organization that is authorized to use the wireless priority service and based on the active status indicating that a mobile station international subscriber directory number (MSISDN) associated with the user is active.
